(19) United States
(12) Patent Application Publication
(10) Pub. No.: US 2025/0382937 A1
(43) Pub. Date: Dec. 18, 2025

(54) METHOD AND DEVICE FOR CONTROLLING AN INTERNAL COMBUSTION ENGINE

(71) Applicant: Robert Bosch GmbH, Stuttgart (DE)

(72) Inventors: Alexander Hettinger, Wiernsheim (DE); Alexander Eichhorn, Freiberg A.N. (DE)

(21) Appl. No.: 18/875,853

(22) PCT Filed: Jul. 4, 2023
(86) PCT No.: PCT/EP2023/068363

§ 371 Date: Dec. 17, 2024

(30) Foreign Application Priority Data
Jul. 18, 2022 (DE) 10 2022 207 299.5

(51) Int. Cl. F02P 15/02; F02P 5/152; F02P 9/00

(52) U.S. Cl. CPC F02P 15/02; F02P 5/152; F02P 9/007

(57) ABSTRACT

A method and a device for controlling an internal combustion engine which, in a combustion chamber includes a prechamber spark plug and a hooked spark plug. In a first operating range of the internal combustion engine, combustion in the combustion chamber is initiated by the prechamber spark plug, and in a second operating range of the internal combustion engine, combustion is initiated by the hooked spark plug.

### FIELD

The invention relates to a method and a device for controlling an internal combustion engine.

### BACKGROUND INFORMATION

Methods and devices for controlling an internal combustion engine comprising either a prechamber spark plug or a hooked spark plug are described in the related art. The control of such internal combustion engines is respectively adapted to the prechamber spark plug or the hooked spark plug.

### SUMMARY

A method according to an example embodiment of the present invention or the device according to the present invention have an advantage that optimized operation of the internal combustion engine takes place in different operating ranges. Depending on the operating ranges, combustion is initiated either by the prechamber spark plug or by the hooked spark plug. This results in optimized operation of the internal combustion engine in each operating range, thus making it possible to realize advantages in terms of consumption, improved performance or reduced exhaust gases.

Further advantages and improvements result from the measures of disclosed herein. Combustion is initiated by the hooked spark plug by means of a corresponding ignition spark between electrodes of the hooked spark plug. Combustion was initiated by the prechamber spark plug by means of at least one ignition jet which extends into a combustion chamber of the internal combustion engine. Depending on the operating range of the internal combustion engine, combustion is initiated by the prechamber spark plug, after which, with a time offset after the ignition jet, an ignition spark occurs at the hooked spark plug. When combustion is initiated by the ignition spark at the hooked spark plug, this is followed, with a time offset, by an ignition jet into the combustion chamber. This measure makes it possible to reduce the occurrence of soot on the prechamber spark plug or hooked spark plug and also improve combustion. The first operating range, in which combustion is initiated by the ignition jet, is in particular characterized by a high load of the internal combustion engine and operation in which there is a risk of knocking. Initiating combustion by means of the ignition jet reduces the tendency to knock in comparison with initiation by means of an ignition spark, as a result of which the internal combustion engine can be operated in an optimized manner with advantages in terms of consumption or increased performance. Alternatively, any range in which combustion in the combustion chamber can be reliably initiated by the prechamber spark plug can be defined as the first operating range in which combustion is initiated by means of the ignition jet of the prechamber spark plug. Accordingly, the second operating range in which combustion is initiated by the hooked spark plugs is defined as the operating range in which combustion cannot be reliably initiated by the prechamber spark plug. This second operating range is characterized in particular by a low load or an operation for heating an exhaust gas system of the internal combustion engine.

### BRIEF DESCRIPTION OF THE DRAWINGS

Embodiment examples of the present invention are shown in the figures and explained in more detail in the following description.

FIG. 1 shows schematically, an internal combustion engine comprising a prechamber spark plug and a hooked spark plug, according to an example embodiment of the present invention.

FIG. 2 shows different operating ranges of the internal combustion engine according to FIG. 1.

### DETAILED DESCRIPTION OF EXAMPLE EMBODIMENTS

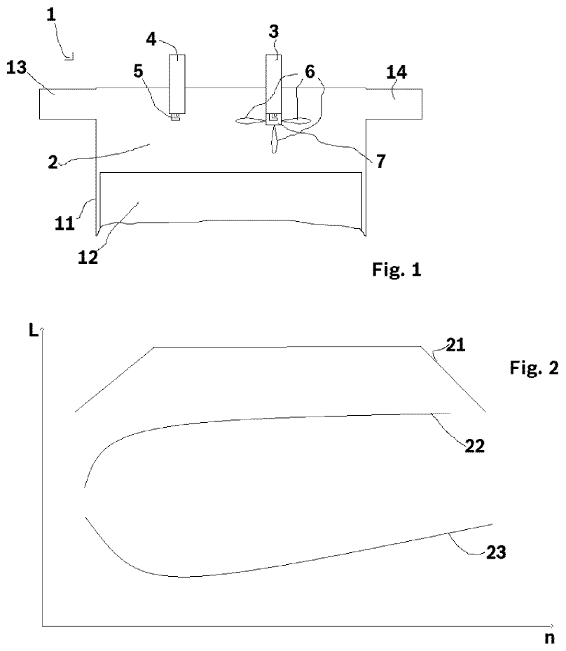

FIG. 1 schematically shows an internal combustion engine 1 with a combustion chamber 2. The internal combustion engine 1 comprises a cylinder 11 in which a piston 12 is disposed. The free-remaining region above the piston 12 of the cylinder 11 defines the combustion chamber 2. Air for combustion can be supplied to the combustion chamber 2 through an air feed inlet 13, and burnt exhaust gas is removed from the combustion chamber 2 through an exhaust gas line 14. The respective valves for controlling the supply of air or the removal of exhaust gas are not shown in the drawing for the sake of simplicity. Fuel, which together with the supplied air forms a combustible mixture, is introduced into the combustion chamber 2 as well. Fuel is fed into the combustion chamber 2 by injecting fuel either into the air feed inlet 13 or directly into the combustion chamber 2. The respective injection valves are not shown here for the sake of clarity. The combustion of the fuel/air mixture in the combustion chamber 2 increases the pressure in the combustion chamber 2, which causes the piston 12 to move up and down. This is therefore a conventional Otto internal combustion engine.

The fuel/air mixture in the combustion chamber 2 is ignited by means of a spark plug. Two different spark plugs, a hooked spark plug 4 and a prechamber spark plug 3, are provided in the combustion chamber 2 of FIG. 1.

The hooked spark plug 4 comprises two (or more) electrodes 5 that project into the combustion chamber 2. An ignition spark can be initiated between the two electrodes 5 of the hooked spark plug 4 which is in direct contact with the combustible fuel/air mixture in the combustion chamber 2 and thus initiates combustion in the combustion chamber 2. Since one of the electrodes 5 is configured as a hook, such spark plugs, which have an ignition spark that is in direct contact with the combustible mixture in the combustion chamber, are referred to as hooked spark plugs. Alternative configurations of the electrodes 5 that deviate from this hook-shaped electrode design are possible too, however. In the following, therefore, the term hooked spark plugs is understood to means all spark plugs in which an ignition spark is in direct contact with the combustible mixture in the combustion chamber 2.

The prechamber spark plug 3 likewise comprises electrodes between which an ignition spark can be initiated. However, this ignition spark is not in direct contact with the combustible mixture in the combustion chamber 2; these electrodes are instead surrounded by a cap 7. The cap 7 comprises openings through which the combustible fuel/air mixture enters the interior of the cap 7 and is ignited by an ignition spark between the electrodes of the prechamber spark plug 3. Combustion of the fuel/air mixture in the interior of the cap 7 then increases the pressure in the interior of the cap 7, so that at least one ignition jet 6 extends out of the cap 7 into the combustion chamber 2. The ignition jet 6 consists of a burning fuel/air mixture, which causes ignition, i.e. starts combustion of the fuel/air mixture in the combustion chamber 2.

FIG. 1 shows a prechamber spark plug that has 3 ignition jets. However, any other number of ignition jets is possible, too. Between the ignition spark inside the cap 7 and the at least one ignition jet, there is a time offset. This has to accordingly be taken into account when controlling the prechamber spark plug 3. This at least one ignition jet 6 then initiates combustion of the fuel/air mixture in the combustion chamber 2. This combustion is initiated simultaneously at many locations of the combustion chamber 2 and not at one location as with a hooked plug. This type of combustion, which is initiated at multiple locations in the combustion chamber 2, results in improved conversion of combustion energy into mechanical power, i.e. combustion is more efficient than when combustion is initiated locally by a hooked spark plug. The use of prechamber spark plugs thus enables advantageous operation of the internal combustion engine 1. It is therefore advantageous to preferably initiate combustion in the combustion chamber 2 by means of the prechamber spark plug 3. This type of combustion, which is initiated at multiple locations in the combustion chamber at the same time, is moreover significantly more effective against knocking combustions. If knocking does occur, the usual procedures for reducing the frequency of knocking can also be used with a prechamber spark plug. The time at which combustion is initiated can therefore in particular be shifted to later points in time in order to avoid the occurrence of knocking.

FIG. 1 shows an internal combustion engine 1 that comprises the 2 spark plugs, a hooked spark plug 4 and a prechamber spark plug 3. The two spark plugs can be used differently depending on the operating ranges of the internal combustion engine 1. FIG. 2 schematically shows operating ranges of the internal combustion engine.

FIG. 2 shows the operating ranges of the internal combustion engine 1 in relation to the operating parameters speed (n) and load (L) of the internal combustion engine. The operation of the internal combustion engine 1 is limited in terms of speed such that operation of the internal combustion engine is not possible below a speed n0 and above a speed n1.

With respect to the load, the depicted curve 21 shows a full-load curve. This full-load curve 21 shows the respective maximum possible load conditions of the internal combustion engine as a function of the speed.

A knock curve 22 is shown as well. The operating range between the full-load curve 21 and the knock curve 22 is the operating range in which there is a risk of knocking, in which knocking can occur depending on other operating parameters of the internal combustion engine 1. Defining this knock curve 22 is a question of interpretation that depends on the percentage of knocking combustions (knocking events) that is permissible. The knock curve 22 is shifted accordingly, for instance if one knocking event per 100,000 combustions or one knocking event per 1,000,000 combustions is used as the criterion. In this operating range in which there is a risk of knocking, combustion is initiated by the ignition jets 6 of the prechamber spark plug 4, because this achieves particularly effective operation of the internal combustion engine 1. The initiation of combustion by the prechamber spark plug 4 moreover generally reduces the tendency to knock, which is advantageous in this operating range as well. If knocking does occur, the tendency to knock can be further reduced by delaying the ignition jets 6. In addition to initiating combustion by means of an ignition jet 6, an ignition spark can also be initiated at the hooked spark plug 4. However, this takes place with a small delay in order to ensure ignition by means of the prechamber spark plug 3. The time offset between the ignition in the chamber 7 of the prechamber spark plug 3 and the occurrence of the ignition jet 6 has to accordingly be taken into account. This additional ignition spark on the hooked spark plug prevents the deposition of soot particles on this hooked spark plug 3. Combustion is moreover generally favored by having a large number of ignition sources, so that a further small improvement of combustion can be achieved by the additional ignition spark on the hook spark plug 3.

FIG. 2 shows the ignition curve 23 that defines a range in which reliable ignition by the prechamber spark plug 4 cannot be ensured as another curve. In particular at a low load, the injected fuel quantities are so low that there is not a sufficiently ignitable fuel/air mixture in the chamber 7 of the prechamber spark plug 4 or the filling in the prechamber spark plug is so low that the resulting ignition jets are too small to ignite the main combustion chamber. Therefore, in a load range below the ignition curve 23, too many combustion processes are not initiated by the prechamber spark plug 4 alone and there are misfires. The exact definition of this ignition curve 23 is a question of interpretation that depends on the percentage of unsuccessful combustions (misfires) due to initiation by a prechamber spark plug 4 that is permissible. The curve 23 is shifted accordingly, for instance if one misfire of 1,000 combustions or one misfire of 100,000 combustions is used as the criterion. Therefore, in the operating range below the ignition curve 23, operation takes place with the hooked spark plugs 3, i.e. combustion is initiated by the hooked spark plugs 3. Additionally sending out an ignition jet 6 from the prechamber spark plug 3 in order to reduce a buildup of soot on the prechamber spark plug 3 or to improve the quality of combustion is possible too, however. This additional ignition jet 6 should have a lesser time offset to the initiation of combustion by the ignition spark, so that the starting point of combustion is actually defined by the hooked spark plugs 3. Here, too, the time offset between the time of ignition inside the prechamber spark plug and the exit of the ignition jet has to be taken into account.

In the operating range between the knock curve 22 and the ignition curve 23, combustion can be initiated by both the hooked spark plugs 3 and the prechamber spark plug 4. However, since initiating combustion by means of the prechamber spark plug 4 generally achieves more efficient combustion, initiating combustion by means of the prechamber spark plug 4 is preferred for this operating range as well. However, depending on other operating parameters of the internal combustion engine, a more differentiated operating strategy may also be provided for this range.

Another operating range is defined by heating an exhaust gas system of the internal combustion engine 1. Such an operation for heating the exhaust gas system preferably uses very late ignition angles. These late ignition angles increase the temperature of the exhaust gas and achieve effective heating of the exhaust gas system. In this type of operation, ignition by means of the hooked spark plugs 3 is advantageous, because combustion can be initiated later with an ignition spark than with an ignition jet from the prechamber spark plug. This operating range is moreover deliberately not effective in order to achieve greater heating of the exhaust gas system. In this operation for heating, combustion is therefore initiated by means of the hooked spark plugs 3.

The optimum time of ignition is determined here by the initiation of the hooked spark plug. The time of ignition of the prechamber spark plug is parameterized with an offset which is selected such that the smooth running of the internal combustion engine is improved. The time of ignition of the hooked spark plug and the offset to the prechamber spark plug is parameterized as a function of engine parameters (speed, load, filling, temperature, etc.). For coking reasons, the prechamber spark plug is preferably always ignited as well, even if there is no advantage in terms of combustion stability. This must be investigated and parameterized specifically for each engine.

Another special operating state of an internal combustion engine 1 is the start of the internal combustion engine 1. When starting, combustion is initiated simultaneously by an ignition jet 6 and an ignition spark. This is intended to ensure a safe start of the internal combustion engine. Only then are the different operating strategies, in which ignition is carried out either by the hooked spark plugs 4 or the prechamber spark plug 3, implemented.

1-9. (canceled)

10. A method for controlling an internal combustion engine which, in a combustion chamber, includes a prechamber spark plug and a further hooked spark plug, the method comprising the following steps:
in a first operating range of the internal combustion engine, initiating the combustion in the combustion chamber by the prechamber spark plug; and
in a second operating range of the internal combustion engine, initiating the combustion by the hooked spark plug.

11. The method according to claim 10, wherein the initiation of combustion by the hooked spark plug is initiated using an ignition spark and the initiation of combustion by the prechamber spark plug is initiated using at least one ignition jet which extends from the prechamber spark plug into the combustion chamber.

12. The method according to claim 11, wherein, when operating in the first operating range in which initiation is carried out by the prechamber spark plug, an ignition spark occurs at the hooked spark plug with a time offset after the ignition jet and, when operating in the second operating range in which combustion is initiated by the ignition spark on the hooked spark plug, an ignition jet occurs in the combustion chamber with a time offset after the ignition spark.

13. The method according to claim 10, wherein the first operating range is characterized by operation of the internal combustion engine in which there is a risk of knocking, including a high load of the internal combustion engine.

14. The method according to claim 13, wherein, when knocking occurs, a time at which combustion is initiated by the prechamber spark plug is shifted in a direction of later combustion.

15. The method according to claim 10, wherein the first operating range is characterized in that combustion in the combustion chamber can be reliably initiated by the prechamber spark plug.

16. The method according to claim 10, wherein the second operating range is characterized in that initiation of combustion in the combustion chamber cannot be reliably initiated by the prechamber spark plug.

17. The method according to claim 16, wherein the second operating range is characterized by a low load or an operation for heating an exhaust gas system of the internal combustion engine.

18. A device for controlling an internal combustion engine which, in a combustion chamber, includes a prechamber spark plug and a hooked spark plug, wherein the device is configured to:
in a first operating range of the internal combustion engine, initiate the combustions in the combustion chamber by the prechamber spark plug; and
in a second operating range of the internal combustion engine, initiate the combustions by the hooked spark plug.
